(19) United States
(12) Patent Application Publication
(10) Pub. No.: US 2008/0021973 A1
(43) Pub. Date: Jan. 24, 2008

(54) COMMUNICATIONS NETWORK ARCHITECTURE

(75) Inventors: Mike R. Manzano, Seattle, WA (US); John C. Haager, Bonney Lake, WA (US)

Correspondence Address: BLACK LOWE & GRAHAM, PLLC, 701 FIFTH AVENUE, SUITE 4800, SEATTLE, WA, 98104, US

(73) Assignee: Topia Technology, Tacoma, WA (US)

(21) Appl. No.: 11/757,220

(22) Filed: Jun. 1, 2007

Related U.S. Application Data
(60) Provisional application No. 60/803,831, filed on Jun. 2, 2006.

(51) Int. Cl. G06F 15/167

(52) U.S. Cl. 709/213

(57) ABSTRACT

A method is implementable in an electronic system having a storage component. The electronic system is coupled to a network. The method includes receiving from a user a request to receive a data set. In response to receiving the request, a mobile object is deployed over the network to a first electronic device. The first electronic device is operable to receive the data set from at least one data source. The mobile object is operable to identify and deliver to the storage component the data set. The data set is received from the mobile object. The data set is provided to a second electronic device in response to a user instruction.

### PRIORITY CLAIM

The present application claims priority from U.S. Provisional Application No. 60/803,831 filed Jun. 2, 2006, which is hereby incorporated by reference in its entirety as if fully set forth herein.

### FIELD OF THE INVENTION

Embodiments of the invention relate generally to computer systems and, more particularly, to accessing data over a network.

### BACKGROUND OF THE INVENTION

Most current data communication systems are not sufficiently flexible and/or powerful to handle many increasingly common situations. For example, a person is expecting an important fax before heading to the airport. It is late and he must leave or miss the flight. The fax arrives after his departure. The office administrator scans it into a digital image, loads it into the desktop, and emails it to the person. At his destination, the person cannot view the details but makes several calls based on data within the fax.

In the meantime, several voice mails have been posted on his desk phone. He does not know they are there and will not until the office administrator checks for voice mail. At his hotel, he has only dial-up service to the Net and to collect email. The scanned image is large, slow to load and cannot be manipulated. Further, re-faxing the material results in a poor quality document. As his options are not viable, he orders it delivered using overnight mail.

### BRIEF DESCRIPTION OF THE DRAWINGS

Preferred and alternative embodiments of the present invention are described in detail below with reference to the following drawings.

FIG. 1 is a schematic view of an exemplary operating environment in which an embodiment of the invention can be implemented;

FIG. 2 is a functional block diagram of an exemplary operating environment in which an embodiment of the invention can be implemented; and

FIG. 3 is a functional diagram illustrating an embodiment of the invention.

### DETAILED DESCRIPTION OF THE PREFERRED EMBODIMENT

An embodiment of the invention leverages remote programming concepts by utilizing processes called mobile agents (sometimes referred to as mobile objects or agent objects). Generally speaking, these concepts provide the ability for an object (the mobile agent object) existing on a first (“host”) computer system to transplant itself to a second (“remote host”) computer system while preserving its current execution state. The operation of a mobile agent object is described briefly below.

The instructions of the mobile agent object, its preserved execution state, and other objects owned by the mobile agent object are packaged, or “encoded,” to generate a string of data that is configured so that the string of data can be transported by all standard means of communication over a computer network. Once transported to the remote host, the string of data is decoded to generate a computer process, still called the mobile agent object, within the remote host system. The decoded mobile agent object includes those objects encoded as described above and remains in its preserved execution state. The remote host computer system resumes execution of the mobile agent object which is now operating in the remote host environment.

While now operating in the new environment, the instructions of the mobile agent object are executed by the remote host to perform operations of any complexity, including defining, creating, and manipulating data objects and interacting with other remote host computer objects.

The nature and functionality of mobile objects are further described in commonly owned U.S. patent application Ser. Nos. 11/739,083, 11/739,084, and 11/739,085, each of which was filed on Apr. 23, 2007, and all of which are hereby incorporated by reference as if fully set forth herein.

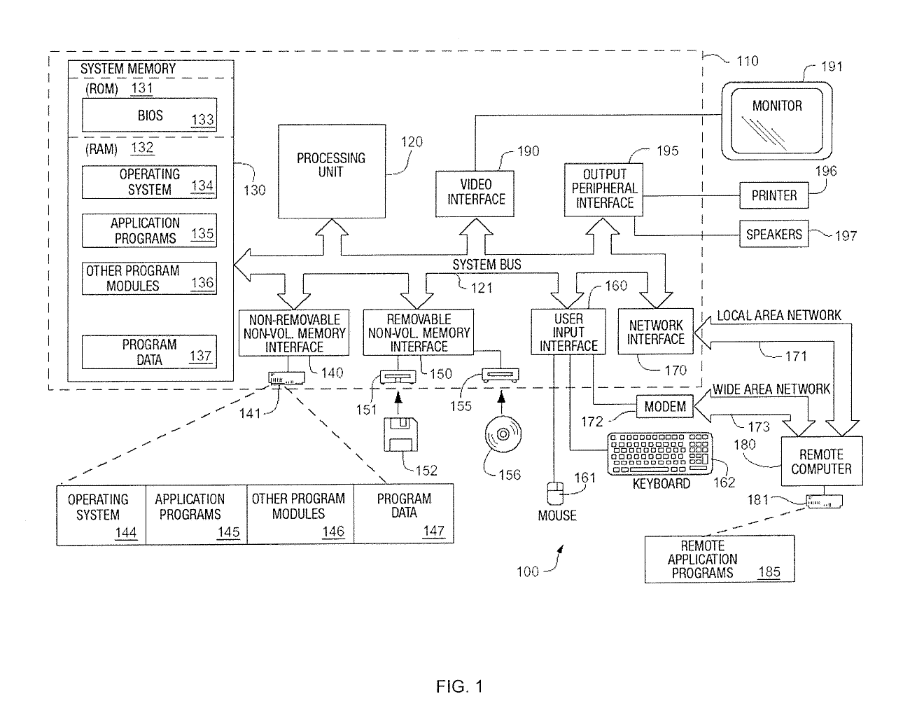

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

Embodiments of the invention are operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

Embodiments of the invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through an non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through a output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

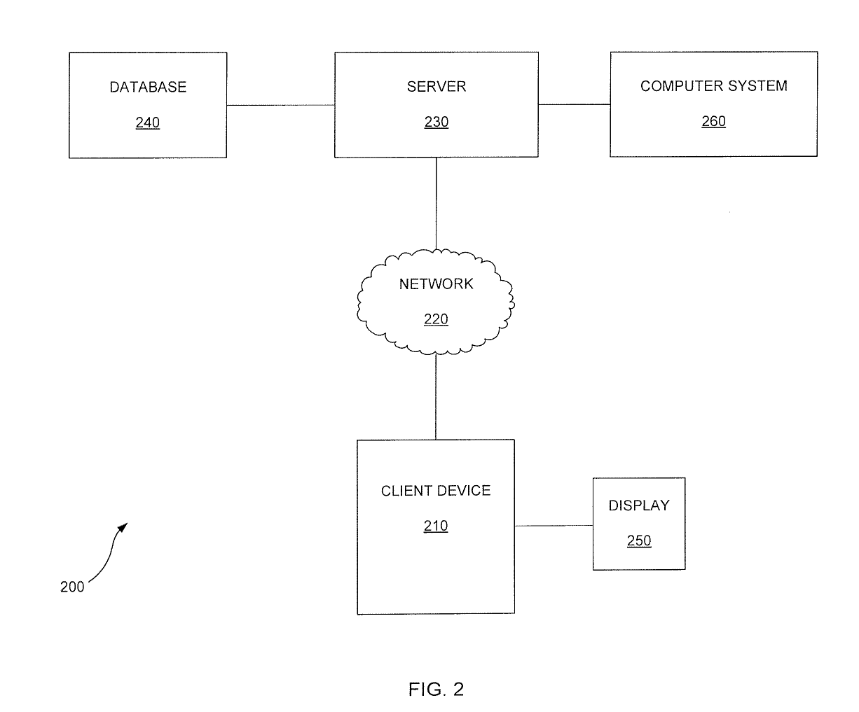

Referring now to FIG. 2, an embodiment of the present invention can be described in the context of an exemplary computer network system 200 as illustrated. System 200 includes an electronic client device 210, such as a personal computer or workstation, that is linked via a communication medium, such as a network 220 (e.g., the Internet), to an electronic device or system, such as a server 230. The server 230 may further be coupled, or otherwise have access, to a database 240 and a computer system 260. Although the embodiment illustrated in FIG. 2 includes one server 230 coupled to one client device 210 via the network 220, it should be recognized that embodiments of the invention may be implemented using one or more such client devices coupled to one or more such servers.

In an embodiment, each of the client device 210 and server 230 may include all or fewer than all of the features associated with the computer 110 illustrated in and discussed with reference to FIG. 1. Client device 210 includes or is otherwise coupled to a computer screen or display 250. Client device 210 can be used for various purposes including both network- and local-computing processes.

The client device 210 is linked via the network 220 to server 230 so that computer programs, such as, for example, a browser, running on the client device 210 can cooperate in two-way communication with server 230. Server 230 may be coupled to database 240 to retrieve information therefrom and to store information thereto. Database 240 may include a plurality of different tables (not shown) that can be used by server 230 to enable performance of various aspects of embodiments of the invention. Additionally, the server 230 may be coupled to the computer system 260 in a manner allowing the server to delegate certain processing functions to the computer system.

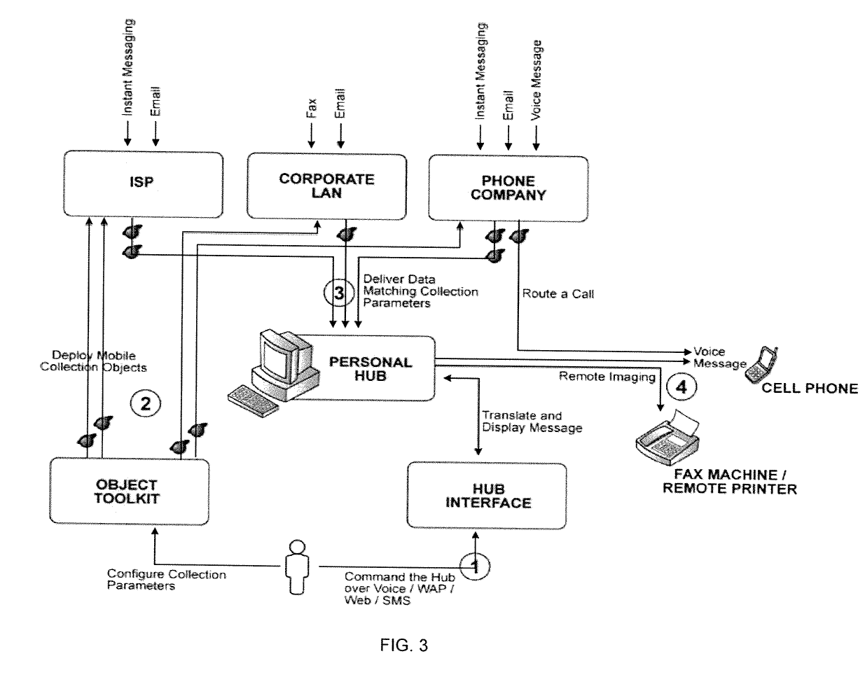

Referring now to FIG. 3, an embodiment includes a data-centric network architecture used to centralize user communications. An embodiment can allow users centralized remote access, and the ability to translate, and deliver instant messages, emails, faxes, SMS text messages, and/or voice calls, including VoIP. An embodiment can translate different communications media.

As described in the following scenario, an embodiment becomes the user's Global Inbox available anytime, anywhere and/or using different communications pathways.

Referring to the exemplary scenario described above, equipped with an embodiment, the person expecting the fax leaves to the airport with no thought of canceling his flight. The fax has not arrived, but that is not important. After it comes in, an embodiment of the invention immediately reconfigures the fax into a digital format, stores it in the server, and forwards it to his desktop. An email alerts the person that the fax is in and permits access to it. This note may come in the form of a text message on his cell phone and he has access to the fax data with a telephone call. Later, he picks up a new fax of the document sent directly to the hotel by his office desktop. In the meantime, all voice mails have been automatically rerouted to his cell phone and stored there as a text message.

As such, one person using an embodiment of the invention accomplishes what has taken people multiple steps in the first scenario. Regardless of the transmission protocol-data, fax, cell, and/or others-data contained in the original fax may be immediately available. Geography-independent, the data is available as long as there is a communications pathway to the user. The costs and time to achieve delayed delivery in the first scenario are eliminated with timely and accurate data transfer in the second.

At the network level, an embodiment of the invention provides subscribers with a personal data “Hub” which may be similar to the server 230 of FIG. 2 and may contain or have access to a database of their messages, address book, and/or other information relevant to the process of delivering, routing, and/or receiving messages of any type. The Hub may also include and/or be operable to execute software programs for translating between different communications media.

Messages may be delivered to the “infrastructure sources” (which may include ISPs, Corporate LANs, and/or Phone Company networks) by normal existing means, such as email or fax. Mobile collection objects deployed by the subscriber using the personal Object Toolkit collect messages from these sources and deliver them to the subscriber's Hub via a network such as network 220. Because the subscriber tells the mobile collection objects what types of message to collect, the subscriber can control when and how a message is delivered to the Hub. Furthermore, the mobile objects can “fire alarm” using any of the subscriber's communication schemes for important messages.

When the messages arrive at the Hub, the subscriber can employ an electronic device, such as, for example, the client device 210, to use the Hub Interface to move messages back and forth between any accessible delivery points. These delivery points can include a WAP browser, a user's laptop, and/or even a fax machine at a hotel.

FIG. 3 shows linkages of an embodiment of the invention between a typical subscriber, the Personal Hub, which, in an embodiment, may include a server, and the array of message sources a subscriber may interact with on a daily basis.

1. The subscriber accesses his Personal Hub using the Hub Interface which, in an embodiment, may include a browser application or other executable client. Alternatively, the Hub Interface may include one or more pages accessible to a browser application.

2. The subscriber assigns mobile objects from the object toolkit to seek out and monitor data received from information sources, such as, for example, ISPs, Corporate LANs, and/or Phone Company networks. The subscriber may so assign mobile objects using, for example, the Hub Interface. For example, the Hub Interface may lead, using one or more web pages or other appropriate interface devices, the subscriber through an interview to discern what types of files the subscriber wishes monitored and the preferred disposition (e.g., preferred presentation format, preferred destination, whether to send to the Hub, etc.) of such monitored files.

3. The Mobile Objects collect data and/or communications and returns them to the Hub.

4. At the Hub, the Mobile Objects make available for display the data to the subscriber, and/or reformats the data to fit other User form-factors.

In an embodiment of the invention, using mobile objects to collect data provides several benefits:
A single access point for all messages.
The system adds value to existing communications channels. For example, a friend of a user might send an instant message to a user. If a user is unavailable, the appropriate object may ask his friend if he would like to leave a text message for the user. The object can then deliver the message to the user's cell phone using SMS. None of this would have been possible using instant messenger alone.
Because the user describes the collection criteria to his mobile object, spam and unwanted messages may be greatly reduced if not completely eliminated by defining the criteria to exclude the collection of spam and unwanted messages.
The user's personal hub may, in an embodiment, be accessible only by mobile object providing increased security, as only one security model has to be defined (instead of one model for each communications method).
The user can translate any type of message into any other medium for appropriate delivery.
The user can do all of this remotely from anywhere at anytime independent of which device he wishes to use. The Hub can even be accessed and/or commanded using a pay phone (i.e., the Hub can be configured to be accessed and instructed using voice commands).
Third parties can use an API of an embodiment to program “intelligent” mobile objects that they can market to end users for their personal use.

While a preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A method implementable in an electronic system having a storage component, the electronic system being coupled to a network, the method comprising:
receiving from a user a request to receive a data set;
in response to receiving the request, deploying a mobile object over the network to a first electronic device, the first electronic device being operable to receive the data set from at least one data source, the mobile object operable to identify and deliver to the storage component the data set;
receiving the data set from the mobile object; and
providing the data set to a second electronic device in response to a user instruction.

2. The method of claim 1, further comprising converting the data set from a first format to a second format prior to providing the data set to the second electronic device.
